(19) United States
(12) Patent Application Publication
(10) Pub. No.: US 2008/0055303 A1
(43) Pub. Date: Mar. 6, 2008

(54) DISPLAY UNIT AND ELECTRONIC DEVICE

(75) Inventor: Masayuki Ikeda, Shiojiri (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/848,572

(22) Filed: Aug. 31, 2007

(30) Foreign Application Priority Data
Aug. 31, 2006 (JP) 2006-236011
Jun. 22, 2007 (JP) 2007-164642

(51) Int. Cl. G06F 3/038; G09G 5/00

(52) U.S. Cl. 345/214; 345/519

(57) ABSTRACT

A display unit that receives a signal from a display control section and makes a display corresponding to display data represented by the signal, the unit including: a display element; a drive unit that drives the display element; a wireless reception section that wirelessly receives the signal from the display control section as an electromagnetic signal; and a demodulation unit that reproduces the display data from the electromagnetic signal received by the wireless reception section and supplies the reproduced display data to the drive unit.

### RELATED APPLICATIONS

This application claims priority to Japanese Patent Application Nos. 2006-236011 filed Aug. 31, 2006 and 2007-164642 filed Jun. 22, 2007 which are hereby expressly incorporated by reference in their entirety.

### BACKGROUND

1. Technical Field

The present invention relates to a display unit for application to an electronic device such as a mobile phone, a notebook computer, or a digital camera and to an electronic device using the display unit.

2. Related Art

Recently, remarkable functional improvements have been made in mobile phones, notebook computers, digital cameras, and the like. As a result, display elements and imaging elements employed in such electronic devices are required to have high resolution and definition, and are becoming increasingly complex. In mobile phones in particular, the demand is not only for more functionality, e.g., a camera function and a larger display section, but also for smaller size and weight, along with less power consumption. Also for mobile phones, the recent housing trend is towards a folding type of housing called a clamshell or a flip.

In electronic devices equipped with such display elements and imaging elements, the demand is increasingly growing for a larger display section with higher resolution, and for smaller and lighter electronic devices. To meet such a demand, a packaging substrate is often partitioned into a plurality of portions for partition packaging.

With partition packaging as shown in FIG. 12, a display element includes a module 1201 having a drive circuit or the like to function independently from other components. Module 1201 is connected by a cable 1202 to the side of the device body through a connector 1203. The cable 1202 is exemplified by a flat cable or thin coaxial cable printed on a flexible substrate.

As the resolution of the elements becomes higher, the signal frequency is increased for a line connecting the side of the display element (module) and the side of the device body, and the number of signal pins is also increased. The result of this is that it is difficult to establish a connection. The demand for electronic device size reduction leads to the demand for connector size reduction, and this reduces the reliability of the resulting connectors.

Currently available connectors for use with a mobile phone and the like have extremely low guarantees for insertion and withdrawal.

To solve such a problem, some attempts have been made to reduce the number of signal pins by enhancing the speed for data transmission. Japanese Patent No. 3086456 (paragraph 0044) and Japanese Patent No. 3330359 (paragraph 0046) describe a data transmission mode of using LVDS (Low Voltage Differential Signaling) for connecting display elements and imaging elements.

Unfortunately, however, such technologies do not yet yield performance capabilities suitable for providing the desired performance in the recently enlarged display elements. That is, to achieve sufficient noise immunity (interference resistance and interference susceptibility) with serial small-signal transfer such as LVDS, the design and adjustment are required to be made with meticulous attention. Another problem with LVDS is the small signal amplitude, which increases the power consumption because analog signals are inevitably handled by digital ICs (Integrated Circuits).

Impedance termination with good matching is required to achieve accurate signal transmission. However, unlike in transmission lines such as cables or parallel lines, the designing of impedance is not easy in the connector section. As a result, mismatching is observed in connection sections designed using known technologies. Moreover, a large number of the lines require impedance termination, and the transmission impedance is about 100 ohms at best. This results in a problem in that the electric power to be consumed for termination resistance increases to an unacceptable level.

Furthermore, with the high-speed data transfer described above, the number of signal pins is still more than 10, and these signal pins are connected using a flexible substrate via connectors. The disadvantage of a flexible substrate and connectors is the high cost and the low reliability of the connection. Moreover, the physical space needed for wiring imposes severe restrictions on electronic device design.

These problems are expected to be solved all at once by the wireless communications technologies of “Nikkei Micro-Device” December 2003, pp. 161, JP-A-10-256478 (paragraphs 0015 to 0025, and FIG. 1, JP-A-2000-124406 (paragraph 0018, and FIGS. 2A and 2B), JP-A-2000-68904 (paragraph 0007, and FIGS. 2A and 2B), and JP-A-2003-101320 (paragraphs 0015 to 0018, and FIGS. 2A and 2B), i.e., such previous technologies are applied to signal exchange between blocks of an electronic circuit and those of an integrated circuit, and any data of a portion difficult for wiring is wirelessly transferred using an electromagnetic (radio) signal.

However, applying conventional wireless communications technologies to data transfer in electronic devices is very complicated and difficult for implementation compared with a transmission system using a lead.

For implementation, the placement of an antenna is especially difficult for establishing a connection in the electronic devices, but none of JP-A-10-256478, JP-A-2000-124406, JP-A-2000-68904 and JP-A-2003-101320 shows an effective solution. For example, JP-A-2000-124406 describes integrating a quarter-wave antenna for radio waves of 1.5 GHz on an integrated circuit, but considering that the wavelength of radio waves of 1.5 GHz is 20 cm, it is obviously impossible to integrate, on the integrated circuit, the quarter-wave antenna, i.e., an antenna of 5 cm.

JP-A-2000-68904 and JP-A-2003-101320 describe a configuration in which an insulator film is formed on a semiconductor chip, and a flat-shaped antenna radiator is disposed on the insulator film. However, the insulator film on the semiconductor chip is not thick enough to allow irradiation of electromagnetic waves with good efficiency from the radiator disposed thereon.

For mobile phones and the like, eliminating interference to/from a transmitter/receiver is also a problem to be solved. The transmitter/receiver serves the fundamental purpose of enabling communications over a distance. However, there is no previous wireless communications technology that can allow wireless communications at a very close distance inside of such equipment under any extreme circumstances, e.g., wherein a transmitter emitting radio waves of extremely high power is provided in the same housing.

There is another problem. That is, the operating voltage for a semiconductor process is recently decreasing due to recent progress in this area. 5V has been long used as a TTL (Transistor-Transistor-Logic) level for the power supply voltage and the signal amplitude of an IC. Recently 3.3V has become popular for the power supply voltage and the signal amplitude thereof.

The concern here is that, with the continuing progress of the semiconductor process, the operating voltage shows a tendency of decreasing down to about 1V. The issue therefore is the signal amplitude level of interface for connecting a plurality of ICs. The value widely acknowledged as standard for the signal amplitude level is 3.3V, and thus arbitrarily adopting any other signal amplitude levels as design discretion surely results in confusion, e.g., a large number of standards are required.

In an attempt to avoid such possible confusion, with a current solution, an interface circuit is provided in every IC to enable operation with a power supply voltage appropriate for the respective processes inside the ICs, and to convert the level of power supply voltage into the standard signal level of 3.3V.

With the advanced IC process, every IC chip is internally operating with a low voltage of about 1V but an interface portion connecting the IC chips is specially provided with a circuit for converting the signal level to 3.3V.

This imposes restrictions on the performance capabilities of the ICs in view of power consumption and operation speed of the conversion circuit. This also requires separation, in the manufacturing process of the ICs, between a portion operating with any appropriate operating voltage in the internal circuit, and a portion operating with a 3.3V power supply for conversion into 3.3V, thereby complicating the manufacturing process.

Moreover, because the signal level is high, the electromagnetic energy that is unnecessarily emitted as noise is also increased, thereby resulting in a difficulty in taking measures against EMI (ElectroMagnetic Interference).

### SUMMARY

An advantage of some aspects of the invention is to provide a display unit and an electronic device carrying therein the display unit, which can eliminate disadvantages and restrictions that have been often observed in the previous connection technologies between a circuit in the electronic device and the display unit, solve the above-described problems in terms of implementation, and offer low cost and high reliability.

A first aspect of the invention is directed to a display unit that receives a signal coming from a display control section, and makes a display corresponding to display data represented by the signal. The display unit includes: a display element; a drive unit that drives the display element; a wireless reception section that wirelessly receives, the signal coming from the display control section as an electromagnetic signal; and a demodulation unit that reproduces the display data from the electromagnetic signal received by the wireless reception section, and supplies the reproduced display data to the drive unit.

With the display unit of the first aspect, signal exchange that was previously made via a connector is now made wirelessly so that various problems associated with conventional connectors can be solved all at once. Moreover, the display unit of the first aspect does not require an interface circuit for converting the signal level of an operating power supply voltage (which vary among semiconductor processes) to make a standard signal level. This is because the display unit of the first aspect is provided with an amplifier circuit that amplifies a reception signal that is weak in communications using electromagnetic waves. With the amplifier circuit, the reception signal is always amplified up to a logic level on the reception end. This configuration can increase the flexibility for device design, and improve the reliability of the devices because no connector is used.

According to a second aspect of the invention, in the display unit of the first aspect, a power reception section is further provided for wirelessly receiving electric energy for supply to the display element, the drive unit, and the demodulation unit.

With the display unit of the second aspect, the electric energy for the display element section is supplied with no contact point so that the display element and the body section can be coupled together completely without wiring, i.e., wirelessly coupled, and thereby use no connector at all. This configuration can accordingly increase the flexibility for device design, and improve the reliability of the devices because no connector is used.

According to a third aspect of the invention, in the display unit of the first or second aspect, the wireless reception section is disposed to receive, from transmission elements which are paired and opposed to a section including a conductor of the wireless reception section, a modulating signal related to the display data to be supplied to the transmission elements.

With the display unit of the third aspect, a pair of opposing elements is wirelessly coupled together for transmission of display data. Accordingly, the electromagnetic energy needed for coupling of this portion is considerably small, and even if leaked, the electromagnetic energy is small. The influence possibly exerted on the device can be thus minimized.

According to a fourth aspect of the invention, in the display unit of the third aspect, the wireless reception section and the transmission elements are enclosed by the conductor in the pair.

With the display unit of the fourth aspect, a pair of elements to be wirelessly coupled for transmission of display data is enclosed by a predetermined conductor so that the influence possibly exerted on/by the device can be minimized with the shielding effects of the predetermined conductor.

According to a fifth aspect of the invention, in the display unit of any one of the second to fourth aspects, a substrate supports the conductor that forms at least a part of the wireless reception section, and at least one of the display element, the drive unit, and the power reception section.

With the display unit of the fifth aspect, the conductor configuring at least a part of the wireless reception section is incorporated onto a substrate supporting the components of the display unit. This enables considerable space savings for a function section related to wireless coupling for the transmission of display data so that the device can be effectively reduced in size. Especially when this conductor is configured on a semiconductor integrated circuit substrate supporting the demodulation unit, this fosters more size reduction, more reliability, and more cost reduction of components.

According to a sixth aspect of the invention, in the display unit of any one of the second to fifth aspects, a conductor configuring at least a part of the wireless reception section is integrated on an integrated circuit substrate that supports a circuit configuring the power reception section.

With the display unit of the sixth aspect, a conductor configuring at least a part of the wireless reception section is integrated on an integrated circuit substrate supporting a circuit configuring the power reception section. Such a configuration can reduce the number of components, and the number of pins for connection with an integrated circuit, thereby achieving size reduction, improving reliability, and improving performance capabilities.

According to a seventh aspect of the invention, in the display unit of any one of the first to sixth aspects, a coupling section for wirelessly transmitting the electromagnetic signal is configured by the wireless reception section and transmission elements which are paired and opposed to a section including a conductor of the wireless reception section, and the coupling section includes an inductance element that transfers electric energy by electromagnetic induction.

With the display unit of the seventh aspect, the function section related to wireless coupling for transmitting display data includes an inductance element for transmitting the electric energy by electromagnetic induction, thereby also enabling power supply. This inductance element can also be used for signal transmission, and any possible influence thereof can be eliminated so that the wireless coupling section can be configured by a fewer number of components. As such, the device can be reduced in size, and this fosters more flexibility for device design.

According to an eighth aspect of the invention, in the display unit of any one of the first to seventh aspects, the demodulation unit includes a UWB demodulation section that receives a UWB-modulated UWB signal representing the display data provided by the display control section, and extracts a signal representing the display data from the received UWB signal.

With the display unit of the eighth aspect, data transmission between the display section and the display control section is carried out by UWB (Ultra Wide Band) communications so that the transmission capacity and speed can be sufficient even with wireless transfer of large amounts of display data. Also with UWB communications, the electromagnetic energy for data transfer is distributed over a wide range of the band, thereby minimizing any possible influence of interference to/from any other devices. The circuit needed for UWB modulation/demodulation occupies a small area, and thus it can be easily disposed and requires less power consumption. The power consumption is constant per a bit of transferring data, and in a standby mode of not transferring data, the power can be suppressed to a minimum (zero). With such characteristics of UWB communications, the system can always be operated with appropriate power consumption in accordance with the operating status thereof.

A ninth aspect of the invention is directed to an electronic device, including: a display signal generation section that generates a display signal representing display object; a display section that makes a display on a display element based on the display signal generated by the display signal generation section; and a coupling section that is interposed on a transmission path on which the display signal to be generated by the display signal generation section is transmitted to the display section. In the electronic device, the coupling section includes: a wireless transmission section that is configured with a circuit of the display signal generation section on a substrate supporting the circuit, and wirelessly sends out the display signal; and a wireless reception section that is configured with the display element of the display section on a substrate supporting a drive circuit that drives the display element, and receives the display signal provided wirelessly by the wireless transmission section.

With the electronic device of the ninth aspect, a display signal generated by the display signal generation section on the side of the body of the electronic device is transmitted to the side of the display section without an electrical contact mechanism but through a coupling section, which is configured to include the wireless transmission section and the wireless reception section. Through such signal transmission, display can be made on the display element on the side of the display section based on the display signal. This favorably solves the problems resulting from conventional connectors, e.g., problems of reliability and durability, and better still, the device design flexibility can be improved.

According to a tenth aspect of the invention, in the electronic device of the ninth aspect, the wireless transmission section of the coupling section includes a transmission element serving as a transmission antenna that emits an electromagnetic wave in response to an output of a transmission modulation circuit section generating a carrier signal which is the result of modulation performed in accordance with the display signal, or as an inductance element of inductive coupling or a capacitive element of electrostatic coupling, and the wireless reception section of the coupling section includes a reception element that receives the electromagnetic wave emitted by the transmission element for supply to a demodulation circuit demodulating the display signal as a result of the electromagnetic wave.

With the electronic device of the tenth aspect, the wireless transmission section of the coupling section includes a transmission element serving as a transmission antenna that emits an electromagnetic wave in response to an output of a transmission modulation circuit section that generates a carrier signal resulting from modulation performed in accordance with the display signal, or as an inductance element of inductive coupling or a capacitive element of electrostatic coupling. The wireless reception section of the coupling section includes a reception element that receives the electromagnetic wave emitted from the transmission element for supply to a demodulation circuit demodulating the display signal as a result of the electromagnetic wave. With such a configuration, the display signal can be wirelessly exchanged in the coupling section.

According to an eleventh aspect of the invention, in the electronic device of the ninth or tenth aspect, a transmission element of the coupling section includes a conductor of a predetermined shape which is disposed on the substrate supporting the circuit of the display signal generation section, and a reception element of the coupling section includes a conductor of a predetermined shape which is disposed on the substrate supporting the drive circuit driving the display element of the display section.

With the electronic device of the eleventh aspect, in the coupling section, the transmission element is disposed so as to include a conductor of a predetermined shape on the substrate supporting the circuit of the display signal generation section, and the reception element is disposed so as to include another conductor of a predetermined shape on the substrate supporting the drive circuit for driving the display element of the display section. Such a configuration does not require any additional substrate or the like for placement of a conductor serving as the wireless transmission/reception elements in the coupling section so that the configuration can be simplified. Moreover, the transmission element is of a conductor pattern different from that of the reception element, thereby leading to better efficiency compared with a case where these elements are disposed in an integrated circuit.

According to a twelfth aspect of the invention, in the electronic device of the tenth or eleventh aspect, the transmission element of the coupling section includes a conductor of a predetermined shape which is disposed on the substrate supporting the circuit of the display signal generation section, and the reception element of the coupling section is formed in a semiconductor integrated circuit on the substrate supporting the display element of the display section.

With the electronic device of the twelfth aspect, in the coupling section, the transmission element is disposed so as to include a conductor of a predetermined shape on the substrate supporting the circuit of the display signal generation section, and the reception element is formed in the semiconductor integrated circuit on the substrate supporting the display element of the display section. With such a configuration, the side of the display section can be especially reduced in size and simplified.

According to a thirteenth aspect of the invention, in the electronic device of any of the tenth to twelfth aspects, the transmission element of the coupling section and the reception element thereof are disposed to be both at least partially fit in a sphere having the radius of one-half of X of a wavelength of the electromagnetic wave to be transmitted and received between the transmission element and the reception element.

With the electronic device of the thirteenth aspect, especially in the electronic device of any one of the tenth to twelfth aspects, the transmission element of the coupling section and the reception element thereof are disposed to be both at least partially fit in a sphere having the radius of one-half of π of a wavelength of the electromagnetic wave to be transmitted and received between the transmission element and the reception element. This accordingly increases, to a considerable degree, the ratio of energy transmission by induction and electrostatic fields, and the loss ratio of energy between the transmission and reception ends is reduced so that the signal transfer can be realized with high efficiency.

According to a fourteenth aspect of the invention, in the electronic device of any one of the tenth to thirteenth aspects, a distribution coupling section is further provided for wirelessly supplying an electric power by mutual induction to a side of the display section from a circuit with a power supply function disposed on the side of the substrate supporting the circuit of the display signal generation section.

With the electronic device of the fourteenth aspect, the distribution coupling section supplies, with no contact, not only a display signal used to make a display on the display section but also an operating power so that the configuration can be of so-called perfect connector-less.

A fifteenth aspect of the invention is directed to an electronic device, including: a UWB modulation section that subjects transmission data to UWB modulation to convert the data into an electromagnetic signal for output; an emission section that emits, as an electromagnetic wave, the electromagnetic signal provided by the UWB modulation section; a reception section that receives energy of the electromagnetic wave emitted by the emission section; and a UWB demodulation section that subjects, to UWB demodulation, the electromagnetic signal received by the reception section. In the electronic device, the emission section and the reception section are disposed with a minimum distance therebetween being one-half of n (where n is a circular constant) or smaller of a maximum wavelength of the electromagnetic signal to be emitted by the emission section.

With the electronic device of the fifteenth aspect, the configuration includes: a UWB modulation section that subjects transmission data to UWB modulation to convert the data into an electromagnetic signal for output; an emission section that emits, as an electromagnetic wave, the electromagnetic signal provided by the UWB modulation section; a reception section that receives energy of the electromagnetic wave emitted by the emission section; and a UWB modulation section that subjects, to UWB demodulation, the signal received by the reception section. In the configuration, the emission section and the reception section are disposed with a minimum distance therebetween being one-half of π (where π is a circular constant) or smaller of a maximum wavelength of the electromagnetic signal to be emitted by the emission section, and this accordingly increases, to a considerable degree, the ratio of energy transmission by the induction and electrostatic fields, and the loss ratio of energy between the transmission and reception ends is reduced so that the signal transfer can be realized with appropriately high efficiency.

A sixteenth aspect of the invention is directed to an electronic device, including: a display signal generation section that generates a display signal representing display object data; a display section that makes a display on a display element based on the display signal generated by the display signal generation section; and a coupling section that is interposed on a transmission path on which the display signal to be generated by the display signal generation section is transmitted to the display section. In the electronic device, the coupling section includes: a wireless transmission section including a semiconductor integrated substrate and a transmission element for wirelessly sending out the display signal provided by the display signal generation section; and a wireless reception section including a semiconductor integrated circuit and a reception element for receiving the display signal wirelessly provided by the wireless transmission section, and at least one of the transmission element and the reception element are formed on the semiconductor integrated circuits.

With the electronic device of the sixteenth aspect, the configuration includes: a display signal generation section that generates a display signal representing display object data; a display section that makes a display on a display element based on the display signal generated by the display signal generation section; and a coupling section that is interposed on a transmission path on which the display signal to be generated by the display signal generation section is transmitted to the display section. In the configuration, the coupling section includes: a wireless transmission section including a semiconductor integrated substrate and a transmission element for wirelessly sending out the display signal provided by the display signal generation section; and a wireless reception section including a semiconductor integrated circuit and a reception element for receiving the display signal wirelessly provided by the wireless transmission section. At least one of the transmission element and the reception element are formed on each of the above-described semiconductor integrated substrates. This thus leads to advantages of a mode of signal transmission in the coupling section over a wireless transmission path. Moreover, the coupling section can be reduced in size and improved in reliability, and by extension, the electronic device can be reduced in size and improved in reliability in its entirety.

A seventeenth aspect of the invention is directed to an electronic device, including: a display signal generation section that generates a display signal representing display object data; a display section that makes a display on a display element formed on a substrate based on the display signal generated by the display signal generation section; and a coupling section that is interposed on a transmission path on which the display signal generated by the display signal generation section is transmitted to the display section. In the electronic device, the coupling section includes: a wireless transmission section including a transmission element for wirelessly sending out the display signal provided by the display signal generation section; and a wireless reception section including a reception element for receiving the display signal wirelessly provided by the wireless transmission section, and the reception element is formed on the substrate.

With the electronic device of the seventeenth aspect, the configuration includes: a display signal generation section that generates a display signal representing display object data; a display section that makes a display on a display element formed on a substrate based on the display signal generated by the display signal generation section; and a coupling section that is interposed on a transmission path on which the display signal generated by the display signal generation section is transmitted to the display section. In the configuration, the coupling section includes: a wireless transmission section that is configured including a transmission element for wirelessly sending out the display signal provided by the display signal generation section; and a wireless reception section that is configured including a reception element for receiving the display signal wirelessly provided by the wireless transmission section, and the reception element is formed on the substrate. This thus leads to advantages of a mode of signal transmission in the coupling section over a wireless transmission path. Moreover, the relatively-large reception element can be implemented even under the size restrictions on the coupling section, and the frequency for transmission of the display signal can be relatively wide in bandwidth. As such, design flexibility is increased, thereby enabling various demands to be precisely met.

With the various aspects of the invention, the display element and the device body are not connected physically by a connector, i.e., not by physical contact, but by wireless contact. Accordingly, the problems that have been observed in previous display unit connections, e.g., reliability of a connector section, physical size of a connection section, cost, and noise influence to/from device, can be favorably solved, and the resulting display unit can be highly reliable, small, and inexpensive. The designing of the device is also made easy so that the resulting device can be highly reliable and inexpensive.

What is better, there is no longer a need to provide a circuit to a signal coupling portion for deriving a match to any special signal level such as the previous system's 3.3 V so that an IC circuit can be configured with a high degree of efficiency.

### BRIEF DESCRIPTION OF THE DRAWINGS

Aspects of the invention will be described with reference to the accompanying drawings, wherein like numbers reference like elements.

FIGS. 1A and 1B are each a diagram showing the configuration of an embodiment of the invention.

FIGS. 2A and 2B are each a diagram showing details of a wireless coupling section in FIGS. 1A and 1B.

FIGS. 3A to 3D are each a diagram showing an exemplary antenna for use in the wireless coupling section in the embodiment of the invention, and FIGS. 3E to 3H are all characteristic diagrams of the antennas of FIGS. 3A to 3D.

FIG. 4 is a block diagram showing, in detail, the configuration of the embodiment of the invention.

FIGS. 5A is a block diagram showing the configuration of the wireless coupling section in the embodiment of the invention, and FIGS. 5B to 5E are each a timing diagram thereof.

FIGS. 6A to 6D are each a diagram for illustrating the configuration of another embodiment of the invention.

FIGS. 7A to 7C are each a diagram for illustrating the configuration of another embodiment of the invention.

FIG. 8 is a block diagram for illustrating the configuration of still another embodiment of the invention.

FIG. 9 is a block diagram for illustrating the configuration of still another embodiment of the invention.

FIGS. 10A to 10K are each a timing diagram for illustrating the operation in still another embodiment of the invention.

FIGS. 11A and 11B are each a diagram showing still another embodiment of the invention.

FIG. 12 is a diagram for illustrating previous technologies.

### DESCRIPTION OF EXEMPLARY EMBODIMENTS

In the following, embodiments of the invention are described by referring to the accompanying drawings.

### First Embodiment

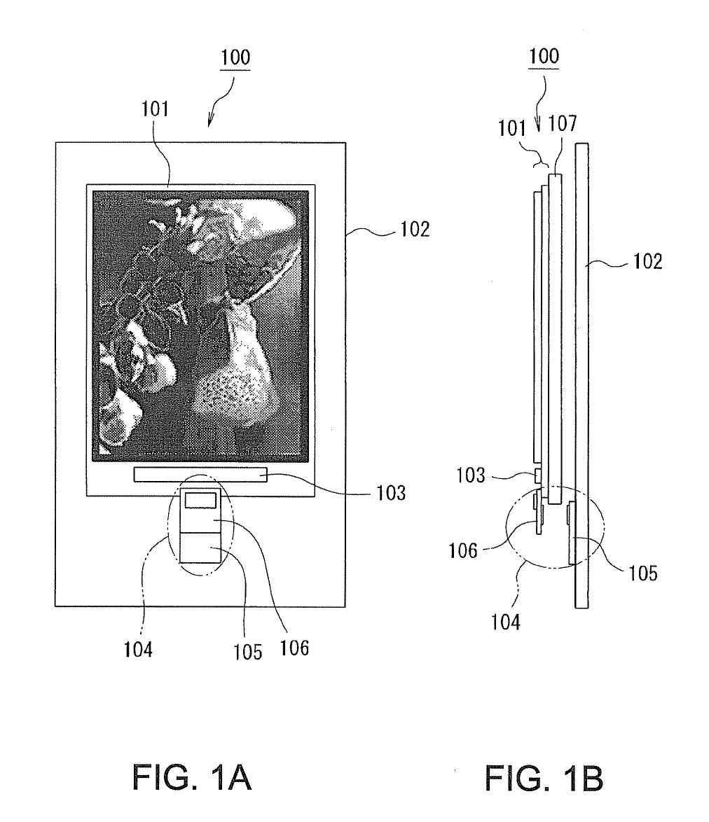

FIGS. 1A and 1B are each a diagram showing the outline configuration of a display unit and that of an electronic device in an embodiment of the invention. FIGS. 1A and 1B each show an embodiment in which a display unit is mounted on a substrate corresponding thereto. FIG. 1A is a front view of the configuration, and FIG. 1B is a side view thereof. In the following, an embodiment to be described by referring to FIGS. 1A and 1B is of an electronic device exemplified by a personal digital assistant (including a case where the device serves as a mobile phone). The electronic device is configured to include a display signal generation section, a display section, and a coupling section. The display signal generation section is configured by a circuit section, which is provided in the body for generating a display signal that represents data serving as a display object. The display section makes a display on a display element based on the display signal generated by the display signal generation section. The coupling section is interposed on a transmission path on which the display signal to be generated by the display signal generation section is transmitted to the display section.

In the example of FIGS. 1A and 1B, the display element is exemplified by a liquid crystal display element 100. The invention is not restrictive thereto, and the display element may be a flat panel display component including a display element being a light-emitting diode, an EL (electroluminescence) element, a plasma display, or others, and in some cases, a display component being a CRT (Cathode-Ray Tube), or others. Such display components also lead to the same effects.

As shown in FIG. 1A, the liquid crystal display element 100 serves as a display section of the electronic device. The liquid crystal display element 100 is configured by a liquid crystal display panel 101 sealed between two transparent plates, and a light guide plate 107 for illumination from the back. The liquid crystal display element 100 is provided with a driving integrated circuit 103. Reference numeral 102 denotes a circuit board on the side of the body of the electronic device (hereinafter, referred to as “the body side” as appropriate). The circuit board 102 is capable of taking charge of original functions of the electronic device including the liquid crystal display element 100, e.g., make calls and e-mail exchange. The circuit board 102 also serves as a display signal generation section, which generates a display signal for making any required displays on the liquid crystal display element 100 being the display element.

The circuit board 102 is provided with a circuit thereon for any other controls, and supports the liquid crystal display element 100 through fixation using a support section (not shown).

A signal coming from the side of the circuit board 102 for display use is transmitted through a wireless coupling section 104 for supply to the driving integrated circuit 103. The wireless coupling section 104 is a coupling section configured to include a wireless transmission section 105 on the side of the circuit board 102, and a wireless reception section 106 on the side of the liquid crystal display element 100.

That is, in the wireless coupling section 104, the wireless transmission section is interposed on a transmission path on which the display signal generated by the display signal generation section is transmitted to the display section, and wirelessly sends out the display signal. The wireless reception section is configured with a substrate supporting the display element of the display section or a drive circuit that drives the display element, and receives the display signal sent out wirelessly by the wireless transmission section. The details about the wireless coupling section 104 will be explained in a later description.

As described in the foregoing, signal exchange between the liquid crystal display element 100 and the side of the circuit board 102 takes place over the wireless coupling section 104. With such a configuration, no contact connection is required so that the problems originating from the reliability of connectors are fundamentally solved. Note here that for any signals not requiring a high speed, e.g., control signals and reset signals needed for the liquid crystal display element 100 and the driving integrated circuit 103 thereof and for power supply thereto, and for signal lines and power supply lines being few in number, establishing a contact connection using connectors with any previous methods may be a possibility.

As in this example, when the wireless coupling section is capable of establishing signal connections requiring a high speed and a large number of pins, the remaining signal lines are few in number and cause no problem in terms of connection therewith. The previous problems described above can thus be substantially solved. If in a configuration of transmitting a part of control signals, e.g., a synchronizing signal, with cable connection, there are effects of being able to simplify wireless connection in terms of synchronous acquisition and tracking.

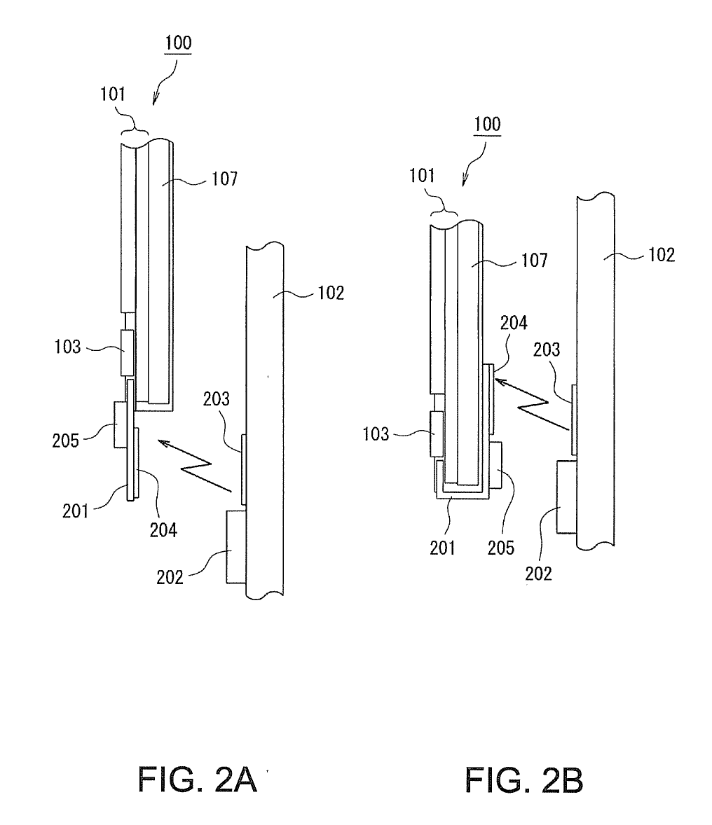

FIGS. 2A and 2B are each a side view showing the details of the wireless coupling section, which is briefly described by referring to FIGS. 1A and 1B. In FIGS. 2A and 2B, any components that are the same as those in FIGS. 1A and 1B are identified with the same reference numerals, and are not described twice.

An integrated circuit 205 carrying therein a wireless reception section is mounted on a substrate 201, and this integrated circuit 205 is connected to the driving integrated circuit 103 mounted, for example, on the glass of the liquid crystal display element 100 through a wiring pattern on the glass. The integrated circuit 205 carrying therein the wireless reception section is connected with a conductor section (reception antenna conductor) 204 serving as an antenna for signal reception, and signals received by this conductor section are input to a front end in the integrated circuit 205.

Herein, the liquid crystal display element 100 is not necessarily mounted on the glass, and alternatively, may be formed on a quartz substrate or a plastic substrate. With this being the configuration, the wiring pattern is also provided on the quartz substrate or the plastic substrate.

In the embodiment of the invention, elements of the reception and transmission antennas may be determined based on any required specification and the like, e.g., the elements are conductors, combination of a conductor and a dielectric element, or combination of a conductor, a dielectric element, and a magnetic substance.

Data for display is generated by a circuit mounted on the circuit board 102 on the body side, and is emitted as an electromagnetic signal to take charge of propagation of data. The signal emission is made from an integrated circuit 202 carrying therein the transmission section using the conductor section serving as a transmission antenna (hereinafter, referred to as transmission antenna conductor) 203.

The circuit board 102 on the body side is exemplified by a double-sided substrate, a multilayer wiring board, a build-up substrate, and the like. The circuit board 102 is made of a glass epoxy resin, a BT resin, an aramid-epoxy composite, a ceramic material, and others. The substrate 201 is generally a tape substrate, a film substrate, and the like, and the material thereof is often a polyimide resin.

To incorporate the integrated circuit 205 onto the substrate 201, the integrated circuit 201 may be mounted face-up on the substrate 201, or alternatively, the integrated circuit 205 may be mounted flip chip on the substrate 201. For flip chip mounting of the integrated circuit 205 on the substrate 201, for example, possible bonding includes ACF (Anisotropic Conductive Film) bonding, NCF (Nonconductive Film) bonding, ACP (Anisotropic Conductive Paste) bonding, NCP (Nonconductive Paste) bonding, and others.

FIG. 2B shows the configuration in which the substrate 201 of FIG. 2A is bent, and the integrated circuit 205 for reception use and the reception antenna conductor 204 are disposed on the rear of the liquid crystal display panel 101. Such a configuration is selected and adopted as appropriate based on the implementation and design of an electronic device.

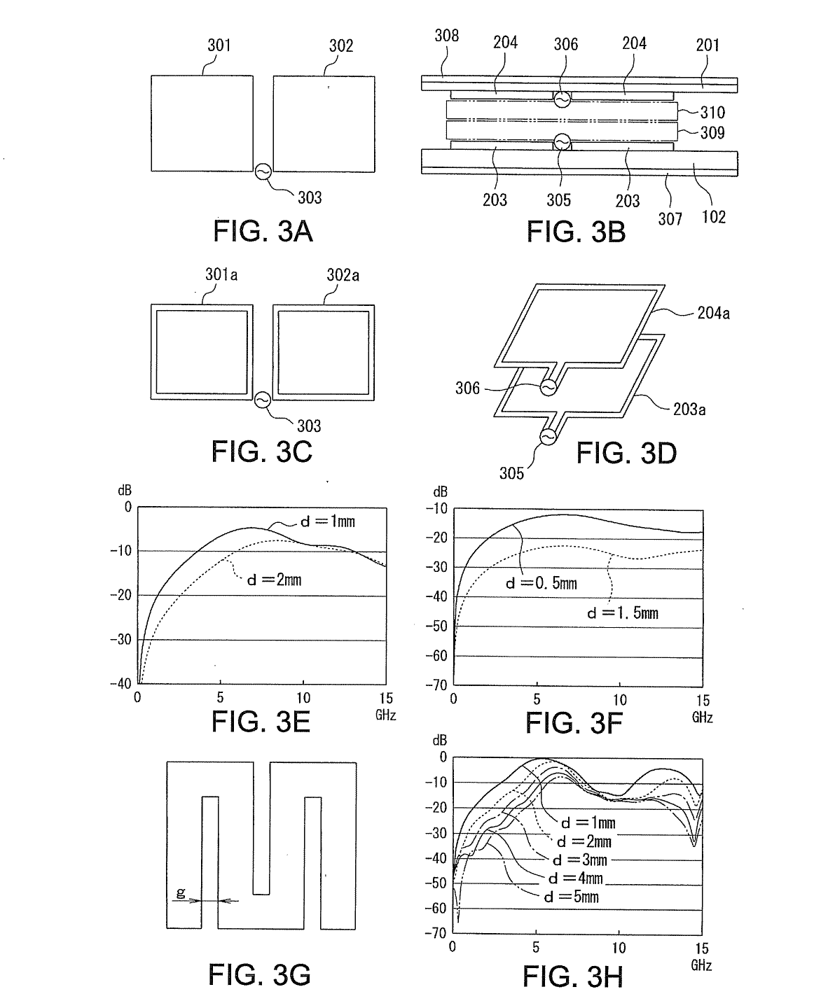

FIGS. 3A to 3D are each a diagram showing an exemplary conductor serving as a transmission or reception antenna. FIG. 3A shows wide-square conductors 301 and 302, and electric power is fed or received where their corner portions are opposing. Reference numeral 303 in the drawings denotes an electric power feeding/receiving point. Note here that the electric power feeding/receiving point is not necessarily set at such a corner portion, and maybe set at any other appropriate position, e.g., at the center of two opposing sides.

FIG. 3B shows a manner of implementing a conductor section of FIG. 3A. When the conductors of FIG. 3A are disposed opposing each other and placed on the substrate 201 on the display element side, the result serves as the reception antenna conductor 204. When the opposed conductors are placed on the substrate 102 on the body side, the result serves as the transmission antenna conductor 203. In FIG. 3B, reference numeral 305 denotes an electric power feeding point, and reference numeral 306 denotes an electric power receiving point.

For the purpose of increasing the degree of coupling, a dielectric element may be disposed between the antenna conductors 203 and 204. As an alternative configuration, dielectric plates (310 and 309 of FIG. 3B) may be affixed to the upper sides of the antenna conductors 203 and 204 (side opposite to the substrate), respectively, and the dielectric plates may be disposed opposing each other.

The recommended configuration is of including conductors 307 and 308 on the side opposite to the transmission antenna conductor 203 and the reception antenna conductor 204 with the substrates 102 and 201 sandwiched therebetween. With such a configuration, by the conductors 307 and 308 covering the wireless coupling section substantially entirely from the outside, no electromagnetic wave is leaked from the wireless coupling section, and any possible external influence of a high electric field can be eliminated.

That is, even if wireless communications is applied to the coupling of internal elements as in the embodiment, the fears can be eliminated about signal leakage and the interference and disturbance caused thereby against the telephone function, which is the original function for the electronic device equipped in the same cabinet (housing). Especially with a mobile phone being an electronic device having the two-way communications function, it is possible to prevent any disturbance possibly caused against wireless communications between the display element and the device body by a high electric field of a function section equipped in the same cabinet for transmission use.

With such a configuration, when the side of the conductors is viewed from the electric power feeding point 305 or the electric power receiving point 306, a capacitor appears as a result of series connection of a capacitor configured by the conductor 301 and the conductor 307 or 308 on the back, and a capacitor configured by the conductor 302 and the conductor 307 or 308 on the back. Herein, the conductors 301 and 302 each serve as the transmission antenna conductor 203 or the reception antenna conductor 204.

When the conductor 301 or 302 is large in size, the resulting capacitor becomes large in capacity, thereby degrading the matching at the electric power feeding/receiving point. Moreover, at the electric power feeding point 305, most of the incoming current flows in the capacitor, and thus the efficiency of energy transfer to the power receiving end is reduced. At the electric power receiving point 306, the current induced by a reception signal is short-circuited by the capacitor, and thus the signal cannot be effectively extracted.

As measures thereagainst, the area of the conductor may be reduced by making the inside hollow as conductors 301a and 302a of FIG. 3C, for example, so that the capacity of the series-connected capacitor is to be reduced, and the effects thereof are to be reduced. With such area reduction, the current flowing along the inside-hollowed conductor induces the electromagnetic waves so that signals can be transferred to the reception end with good efficiency.

As such, the method described by referring to FIGS. 3A or 3C corresponds to a modification of a dipole antenna. As a possible configuration, the conductor may be shaped like a loop as shown in FIG. 3D to provide it with an antenna function. If this is the case, a current coming from the electric power feeding point 305 flows through a loop-shaped conductor 203a, and a signal energy is emitted on the principle of a loop antenna. A conductor 204a on the reception end induces, to the electric power receiving point 306, the electromotive force to be induced in the loop.

Between the loop-shaped conductors 203a and 204a, a magnetic element may be disposed for increasing the magnetic coupling.

FIG. 3E shows a simulation result about the transmission characteristics of the antenna conductors in the examples of FIGS. 3A and 3B, respectively, and FIG. 3F shows a simulation result thereabout in the example of FIG. 3D.

FIG. 3E shows the transmission characteristics (S₂₁) between transmission and reception ends when the antenna conductors of FIG. 3A are opposed as shown in FIG. 3B.

FIG. 3F shows the transmission characteristics (S₂₁) between transmission and reception ends with the antenna conductors of FIG. 3D.

In FIGS. 3E and 3F, reference character d denotes the distance between the antenna conductors. The dimensions during the simulation are as follows.

### FIGS. 3A and 3B

Conductors 301 and 302

Size: Square of 5 mm ×5 mm is disposed with a space of 0.2 mm from another

Material: Copper with thickness of 12 μ

Substrates 102 and 201

Both made of polyimide with thickness of 25 μ (relative dielectric constant=5),

Conductors 307 and 308 with rear shielding: None FIG. 3D

Loop Conductors 203a and 204a

Size: Square with outer dimensions of 3.5 mm, Line width of 0.5 mm

Specifications, e.g., materials of conductor and substrate, are the same as those of FIGS. 3A and 3B

As is evident from these drawings, when the distance d between the transmission and reception ends is about 2 mm or smaller, the loss will be 10 dB or smaller so that the transmission loss to be represented by the transmission characteristics (S₂₁) is considerably small. With such characteristics of an antenna conductor, a link budget for ensuring a communications path can be developed with ease, and the electromagnetic energy needed for transmission can be of an extremely low minimum necessary value.

To reduce the size of the antenna conductor of FIG. 3A as much as possible, the transmission characteristics are possibly shifted to the side of lower frequency. This is achieved by, as shown in FIG. 3G, configuring a meander-shaped element by cutting the conductor of FIG. 3A, i.e., a cut represented by a width g. With an antenna using such a meander-shaped element, the transmission characteristics thereof are shifted to the side of lower resonance frequency so that the antenna can be reduced in size, and as with a case like this aspect of the invention, similar effects can be also achieved.

FIG. 3H shows the simulation result when the conductor of FIG. 3A is cut with the width g of 0.5 mm. As is known from FIG. 3H, improvement is observed for the transmission characteristics. Especially with about d=1 mm, the loss will be 2 dB or smaller, which compares favorably with any loss observed with connectors through normal physical connection. The size reduction as such of an antenna conductor for transmission and reception use favorably reduces the electromagnetic energy needed for transmission so that any possible disturbance over the outside environment can be reduced. What is more, with the smaller physical size, shielding becomes easy so that there are effects of being able to reduce any possible disturbance from outside.

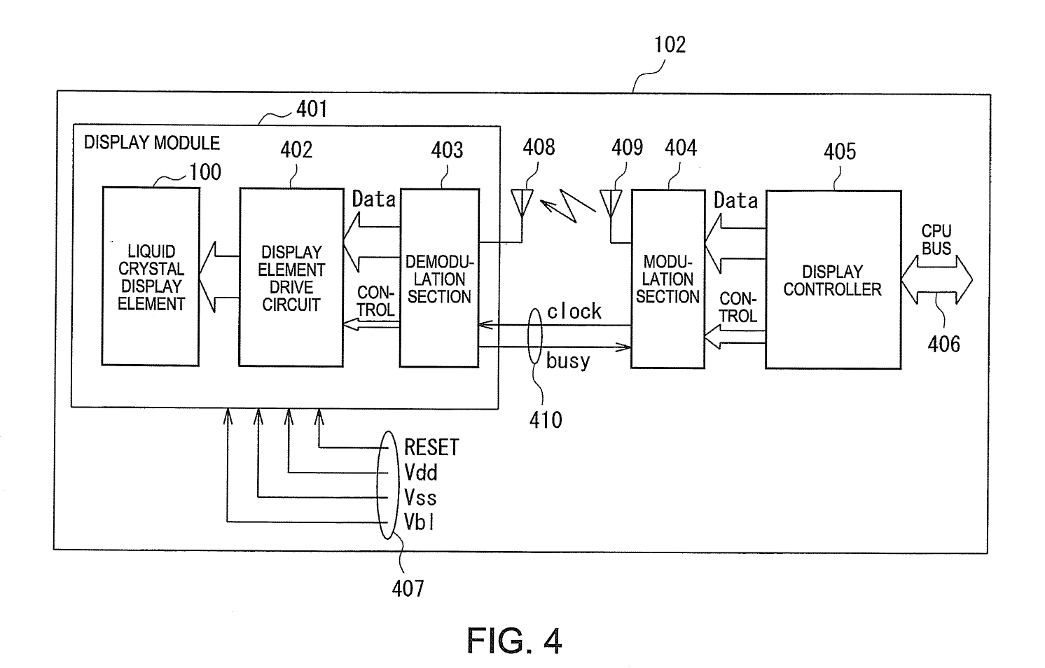

FIG. 4 is a block diagram showing a display unit of an embodiment of the invention, and the main part on the body side for driving the display unit. The circuit board 102 on the body side supports a display controller 405, a modulation section 404, and a display module 401. The display controller 405 serves to receive data from a CPU (Central Processing Unit, not shown) over a CPU bus 406. The data here is for display on the liquid crystal display element 100. The display controller 405 then sequentially outputs the data to the display module 401 (described later) as a display signal. The modulation section 404 serves to receive and modulate the signals coming from the display controller 405 for the purpose of wireless transmission, and sends out the modulation results to a transmission antenna conductor 409.

This display module 401 includes a demodulation section 403 and a display element drive circuit 402. The demodulation section 403 serves to receive a signal from a reception antenna conductor 408, and demodulates the received signal. The reception antenna conductor 408 serves to receive a wireless signal from the transmission antenna conductor 409 for transmission to a stage subsequent thereto. The display element drive circuit 402 serves to drive the liquid crystal display element 100 after receiving the signal from the demodulation section 403.

In this embodiment, signals are provided by a cable, i.e., through a predetermined line 410 of the circuit board 102 on the body side, and in response to the signals, any corresponding components start functioning as predetermined. The signals here include a clock signal for establishing synchronization between the display controller 405 and the display element drive circuit 402, and a signal, e.g., busy signal, coming from the side of the display module 401 for transmission to the display controller 405.

The display module 401 is provided with signal terminals 407 such as power supply (vdd, Vss), backlight power supply (Vb1), and reset signal input (RESET), which are connected by cable at their predetermined positions. These lines transmit power supply energy and low-speed information, and their connections can be easily established. As such, even with cable transmission, the problems that this aspect of the invention is solving are not caused.

As the wireless coupling section of the display unit of the embodiment of the invention, for wirelessly transmitting an electric signal at very close distance, the distance between the transmission and reception points will be one-half of π (where π is a circular constant) or smaller of the wavelength of a signal in use. The wireless coupling section of the display unit of the embodiment of the invention fits in a radian sphere, which is a sphere with the radius of one-half of n or smaller of the wavelength. Assuming that a micro-small loop antenna or a micro-small dipole antenna is disposed at the center of such a radian sphere, the border where three of a radiation field, an induction field, and an electrostatic field all take the same value is the surface of the radian sphere. In the radiation field, the strength of an electromagnetic field generated by the antenna shows a decrease with an inverse proportion to the distance from the center of the radian sphere. In the induction field, the strength of the electromagnetic field shows a decrease with an inverse proportion to the square of the distance, and in the electrostatic field, the strength of the electromagnetic field shows a decrease with an inverse proportion to the third power of the distance.

In the embodiment of the invention, an electromagnetic signal to be transmitted by the wireless coupling section is of a wavelength spreading into a band where the electromagnetic signal is located, and thus the wavelength takes various values of a specific range.

The issue is which value of such a specific range should be taken for the wavelength, and in this example, the longest wavelength in the band for a transmitting electromagnetic signal is selected.

There is no need to take into consideration the size of a radian sphere unlike a micro-size loop antenna and a micro-size dipole antenna. However, because the transmission antenna conductor and the reception antenna conductor are both finite in size, the point where the above-described three fields have the same value does not show distribution of a sphere, and in the entire band of a signal, there is no plane having such characteristics. In this example, the minimum distance between the transmission and reception antenna conductors is regarded as the distance therebetween.

This is because, with a very close range where the size of an antenna is not negligible, the transmission characteristics considerably vary between the side where the frequency is low in the signal band and the side where the frequency is high therein, thereby degrading the transmission characteristics of the band. Moreover, the distance considerably varies between any two arbitrary points on the transmission and reception antenna conductors, and the length of the distance largely varies the transmission characteristics between the two points, thereby also degrading the transmission characteristics of the band.

In consideration thereof, the distance between the antenna conductors is desirably set longer. On the other hand, if the antenna conductors are brought closer to each other, measures can be taken with ease to prevent the electromagnetic energy from leaking outside, i.e., shielding, and any possible energy loss of a transmitting signal can also be reduced.

Considering such advantages and disadvantages, it may be appropriate to set the minimum distance between the transmission and reception antenna conductors to one-half π or smaller of the maximum wavelength in a band of a transmitting signal. Ideally, the transmission and reception antenna conductors may be configured as small as possible, and may be entirely housed inside of a sphere with the radius of one-half of π of the wavelength at the main frequency at least in the band of a transmitting electromagnetic signal.

As such, as described above, the wireless communications to take place within a very close range, i.e., the wireless coupling section in the display unit in the embodiment of the invention shows characteristics considerably different from those of previous wireless communications to take place in a radiation field. Accordingly, one needs to take into consideration any possible influence by an induction field and an electrostatic field, the size of antennas, and the band of a signal.

The specific possible influence is that, firstly, the loss ratio of energy between the transmission and reception ends, i.e., a so-called path loss, is much smaller than a value calculated by the previous Frith's formula. This is because the energy transmission is greatly increased in ratio by the induction and electrostatic fields as is taking place inside of a radian sphere.

Secondly, the antennas on the transmission and reception ends affect each other in terms of characteristics. Previously, there has been no need to take into consideration such influence over characteristics because antennas for use for previous wireless communications are disposed with a distance therebetween, and thus the reception and transmission antennas may be separately subjected to calculation. In the case with this aspect of the invention, however, the transmission and reception antennas affect each other in terms of characteristics. If a device taking charge of energy emission by a radiation field is an antenna, as in the case with this aspect of the invention, the energy transmission between the electrostatic and induction fields has to be additionally considered, and thus there is great uncertainty about whether the device can be referred to as antenna.

This is the reason why, unlike in the previous technologies, the conductors 203 and 204, and the conductors 301 and 302 in FIG. 3A are not explicitly referred to as antennas or antenna elements in the above. When the transmission and reception antennas are brought closer to each other as in this aspect of the invention, a tendency is observed that the resulting radiation impedance is lower as compared with a case where the antennas are disposed with a distance therebetween, and the bandwidth gets wider.

Thirdly, even if there is a metallic element in a close range, unlike the antennas in the previous technologies, the antennas in the embodiment of the invention are not degraded that much in characteristics. When the antennas are separately subjected to calculation as in the previous technologies, the calculation considering the influence of the metallic element in a close range will be onerous, and thus the influence is neglected for calculation. When the influence is considered for calculation, the calculation is performed again with the influence considered. In most cases, the characteristics will be degraded to a considerable degree with such a consideration over the influence. In the case of this aspect of the invention, because the transmission and reception antennas are disposed close to each other, the antennas cannot be separately subjected to calculation with no consideration over the influence, and thus any influential element is taken into consideration from the beginning for calculation. As such, even if characteristics degradation is inevitable, the degree of any possible degradation is considered for calculation at the time of device design so that the influence is eliminated from the beginning.

Fourthly, there is no specific factor of causing characteristic degradation in terms of propagation, e.g., multipath and fading. This may be not because the transmission and reception points are in the radian sphere but because the distance between the points is fixed due to the closeness as such, thereby being not physically susceptible to characteristic degradation.

In the case of FIG. 3A or 3C, the coupling in the electrostatic field is affecting to a large extent, and the coupling in the induction field is affecting to a large extent in the case of FIG. 3D. Especially in the case of FIG. 3C, with mutual induction rather than with loop antennas disposed opposing each other, the configuration may be of so-called M-coupling.

Such considerations ease the link budget and circuit designing of the wireless coupling section, and also ease the circuit designing of a transmitter/receiver.

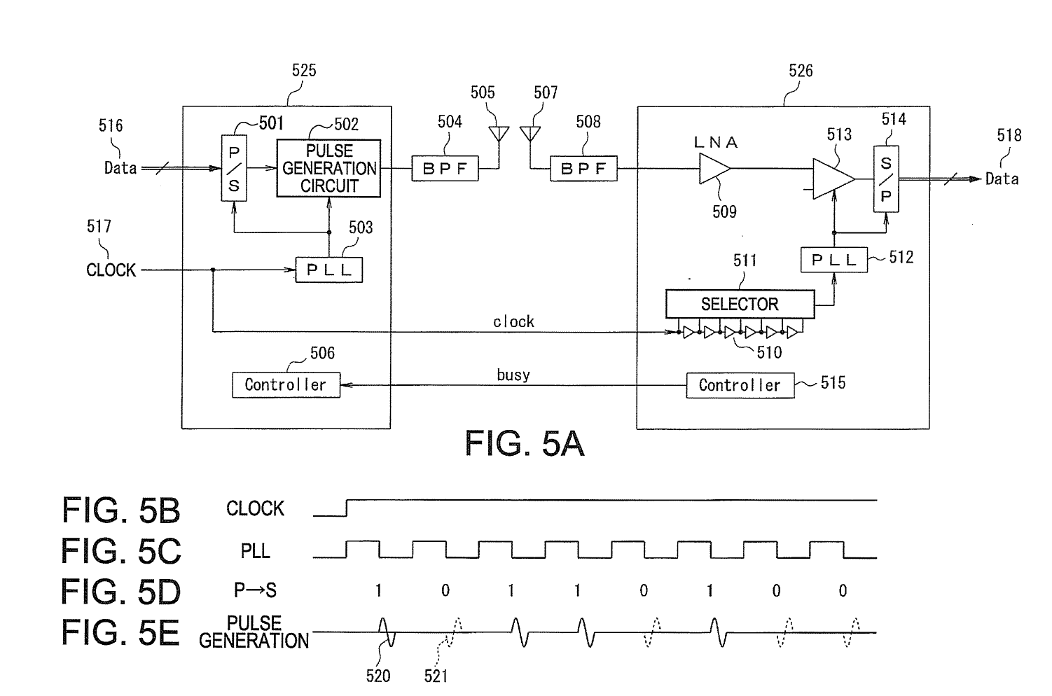

FIGS. 5A to 5E are each a diagram for illustrating the overview of a transmission/reception section in an embodiment designed based on the considerations described above. FIG. 5A is a block diagram of the transmission/reception section, and FIGS. 5B to 5E are each a timing diagram of the main part thereof.

Display data to be generated by the display controller is output in parallel through a plurality of lines, and then is input, via a terminal 516, to a parallel/serial conversion circuit (denoted as P/S in the drawing) 501 inside of a transmission section integrated circuit 525. In the parallel/serial conversion circuit 501, signals of the display data received in parallel are converted into serial signals, and the conversion results are sent out to a pulse generation circuit 502 as a piece of serial data. In the pulse generation circuit 502, a predetermined pulse is generated in accordance with the value of the sending-out data, i.e., the values of 1 and 0, and sends out the pulse to a transmission antenna conductor 505 through a band-pass filter (denoted as BPF in the drawing) 504.

A PLL (Phase-Locked Loop) 503 receives and multiplies the frequency of a clock signal provided to a terminal 517 for use by the display controller and the CPU, and reproduces the high-frequency clock for use by the parallel/serial conversion circuit 501 and the pulse generation circuit 502. The resulting clock signal has the same phase as a clock signal for use by the display controller and the CPU, and synchronization is established therebetween, thereby establishing synchronization also with pulses coming from the transmission antenna conductor 505. The clock signal to be directed to the transmission section may be low in frequency because the PLL 503 generates therein a clock signal of any needed level of high frequency.

Because the display data is transmitted as a parallel signal over a plurality of lines, and the portion of data transmission is thus low in frequency, and the connection is established with ease in this portion. This portion has no unwanted radiation such as EMI and no interference from outside. The display data is only required to be high in frequency after parallel/serial conversion is converted into a signal of high frequency broadband by pulse modulation. However, no cable is used for connection unlike in the previous technologies so that the previous problems resulting from the connection of this portion are entirely eliminated.

Moreover, the interference to the outside and disturbance therefrom can also be completely eliminated by the manner described by referring to FIG. 3B or others, and the resulting configuration enables establishing connections with high reliability at low cost.

A wireless signal emitted from the transmission antenna conductor 505 is received by a reception antenna conductor 507, and then is input into a low-noise amplifier circuit (denoted as LNA in the drawing) 509 in a reception section integrated circuit 526 for amplification through a band-pass filter (denoted as BPF in the drawing) 508. The resulting signal is detected by a pulse detection circuit 513, and then is converted into a parallel signal by a serial/parallel conversion circuit (denoted as S/P in the drawing) 514. The resulting converted signal is then output from a terminal 518 as display data, and sent out to a liquid crystal drive circuit.

The PLL 512 receives a reference signal that is the same as the clock signal. The reference signal is received on the PLL 503 on the transmission end for use by the display controller and the CPU, and multiplies the frequency of the signal. The PLL 512 then reproduces the clock signal for use as a signal for setting of a pulse detection timing of the pulse detection circuit 513, or as a signal for use in the serial/parallel conversion circuit 514. In this case, for the purpose of establishing synchronization with a delay of signal propagation observed in a path from the pulse generation circuit 502 on the transmission end to the pulse detection circuit 513 on the reception end, the clock signal is adjusted in delay amount so that synchronization is established as intended between the transmission and reception ends. The adjustment of delay amount is made by a selector 511 adjusting the number of delay elements 510 for interposing to the circuit in series.

In this embodiment, a clock signal for use by a control section (denoted as Controller in the drawing) 515 and the CPU (not shown) is the same as the clock signal provided to the transmission section integrated circuit 525 from the terminal 517. The clock signal is provided over a cable line (denoted as clock in the drawing), and the control section here is one exercising control over the operation of the reception section integrated circuit 526. Moreover, a signal, e.g., busy signal, from the control section 515 of the reception section integrated circuit 526 to a control section (denoted as Controller in the drawing) is configured so as to be provided by cable over a predetermined line (denoted as busy in the drawing). As such, synchronization can be completely established between the transmission and reception ends. The control section here is one exercising control over the operation of the transmission section integrated circuit 506.

Accordingly, this eliminates the need for a procedure of synchronization acquisition and tracking on the reception end so that an electric device configuration can be simplified.

FIGS. 5B to 5E each show a timing diagram in this embodiment. A clock signal of FIG. 5B is a reference signal for the PLLs 503 and 512. The frequency of this signal is considerably lower than a bit rate of display data immediately after parallel/serial conversion, and thus FIG. 5B shows only the rising edge of the signal. The PLL 503 multiplies the frequency of this signal, and generates a clock signal needed for the parallel/serial conversion circuit 501 and the pulse generation circuit 502, or for pulse detection (FIG. 5C).

The pulse signal generated by the pulse generation circuit 502 may be subjected to OOK (On Of f Keying) modulation, i.e., a pulse is generated when the transmitting display signal (FIG. 5D) takes a value of 1 like a pulse 520, which is indicated by the solid line in FIG. 5E, and no pulse is generated with a value of 0, BPM (Bi-Phase Modulation), i.e., polarity of a pulse is changed between the values of 1 and 0 as indicated by a broken line 521 in FIG. 5E, or others.

Other possibilities include PPM (Pulse Position Modulation) of changing the position of a pulse, or the like.

Communications using pulses as in this embodiment are referred to as impulse radio communications (IR communications), which is a part of ultra wideband communications (UWB communications). With UWB communications, the signal spectrum is widened but the possibly available transmission speed is rapidly increased as the communications distance is reduced, i.e., the transmission speed is possibly higher with the shorter communications distance. Utilizing such characteristics, a large amount of data that has been transmitted using a large number of low-speed data transmission paths, i.e., a large amount of parallel data, becomes able to be transmitted as high-speed serial data using a single wireless transmission path.

With UWB communications, the band of a signal is considerably wide so that the energy density per unit band is reduced to a considerable degree. Accordingly, even if there is overlapping between the band and another band of a signal for use in any other communications systems, the resulting influence is negligibly small. Contrarily, even if a signal coming from any other communications systems enters a receiver, the influence thereof can be favorably eliminated because the interference wave is dispersed at the time of demodulation of the receiver.

Also with UWB communications, there is no operation by the frequency axis unlike the previous modulation operation so that the communications can be taken place only on the time axis, and the circuit simplification can be implemented with ease.

As described in the foregoing, the transmission and reception antenna conductors are originally disposed close to each other so that the outgoing electromagnetic energy can be suppressed to a necessary minimum level. Moreover, with any measures such as shielding the transmission and reception antenna conductors, for example, any possible leakage of the electromagnetic energy to the outside can be minimized or any energy coming from the outside as an interference wave can also be minimized.

With such measures and the original characteristics of the UWB communications, the physical connection of connectors in the previous technologies can be eliminated. As such, the previous problems, i.e., the reliability of connectors, interference over other components, and characteristics of resistance to external interference, can show signs of problem solving.

In this embodiment, the pulse communications makes the most of its characteristics, and for transmission and reception modulation, the possible options include frequency modulation, amplitude modulation, and phase modulation, which are popular. With such modulation schemes, the frequency band is required to be very wide if data is to be transmitted as a piece of serial signal as in this embodiment. However, the frequency band is not as wide as a band required for pulse communications so that the modulation schemes can be used depending on the application purposes.

Also with such modulation schemes, any parallel data can be subjected to multiplexing transmission as it is with the technology of code division multiple, for example. If this is the case, a large amount of data can be transmitted without increasing the transfer speed that much for every transmission path.

### Second Embodiment

In the first embodiment described above, an element configuring an antenna, i.e., transmission and reception elements, is formed by a conductive pattern on a substrate. In a second embodiment, an exemplary case is described where a transmission element and a reception element are formed on at least one of semiconductor integrated circuits of transmission and reception sections.

First of all, an exemplary case is described where an antenna conductor is formed on a semiconductor integrated substrate. The specific manner of forming an antenna conductor on a semiconductor substrate will be described later.

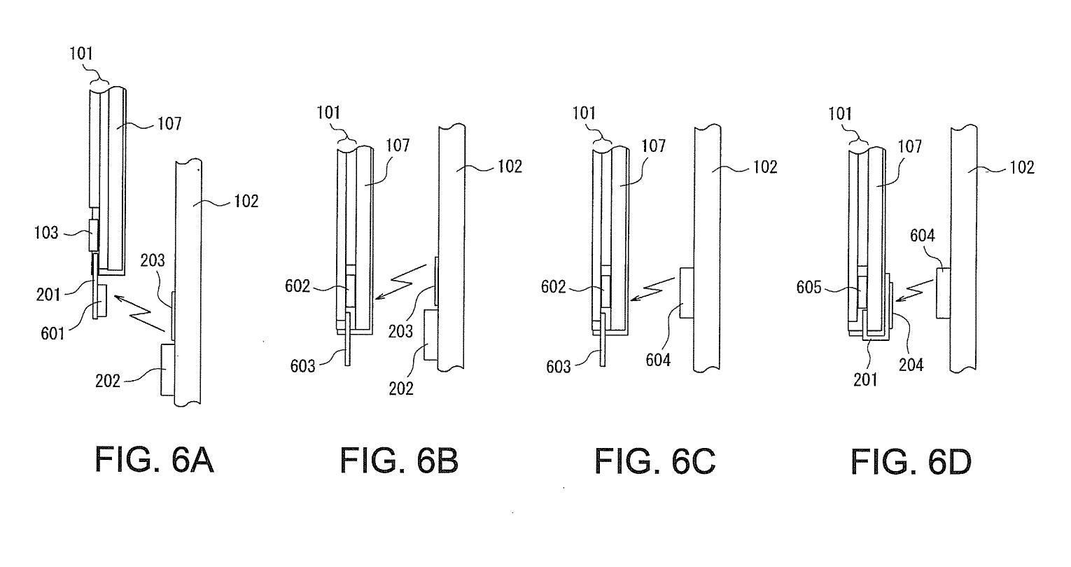

FIG. 6A shows an exemplary case where an antenna conductor is formed on a reception section integrated circuit 601. If an antenna conductor is allowed to be a part of an integrated circuit as such, as in FIG. 6B, an integrated circuit 602 may be able to include both a reception section circuit and an antenna conductor. The integrated circuit 602 here is one carrying therein a display drive circuit. With such a configuration, the number of chips can be reduced in an integrated circuit, and there is no longer a need for a wiring pattern between the display drive circuit and the reception section circuit so that the number of components and wiring patterns are reduced. Such reduction favorably leads to the effects of better reliability and lower cost.

In the configuration, the substrate 603 is not required, but if provided, it may be used for the signal terminals 407, i.e., a wiring pattern, for resetting or power supply, or for the control signal 410 of FIG. 4.

FIG. 6C shows a case where an antenna conductor for the transmission section is also included in the transmission section semiconductor integrated circuit 604. FIG. 6D shows a case where a display drive circuit and a reception section circuits are both integrated on the same integrated circuit 605, and an antenna conductor for reception use is formed by the conductor section 204, i.e., a pattern, on the substrate 201.

When an antenna element is formed on a semiconductor integrated circuit, generally, the radiation efficiency is degraded to a considerable degree, i.e., about 0.01% in a frequency band of a few GHz.

On the transmission end, this loss can be compensated by the increase of a transmission power. However, for compensating any loss on the reception end, the transmission power generally cannot be increased. This is because increasing the power on the transmission end for compensating any loss on the reception end means increasing the signal strength, i.e., strength of a radiation field, on a wireless transmission path. If the signal strength is increased for this purpose, the energy disturbing any other components is also increased. The strength of a radiation field has its upper limit set by law restrictions, and thus the signal strength cannot be increased indiscriminately. As such, the configuration of FIG. 6D is considered most reasonable.

The configuration of FIG. 6D does not require any intense signal that possibly causes a problem of unwanted radiation because the transmission distance by a wireless signal is considerably short. Moreover, shielding or the like as a measure against unwanted radiation is simple and easy as described above by referring to FIG. 3B. Note here that the radiation efficiency of 0.01% is specifically for a radiation field, and as in the embodiment, i.e., wireless connection is established in a radian sphere, signal energy transmission is also available additionally by an induction field and an electrostatic field so that the efficiency shows a value better than 0.01%. With these reasons, the manners of FIGS. 6A to 6C are also considered practical enough.

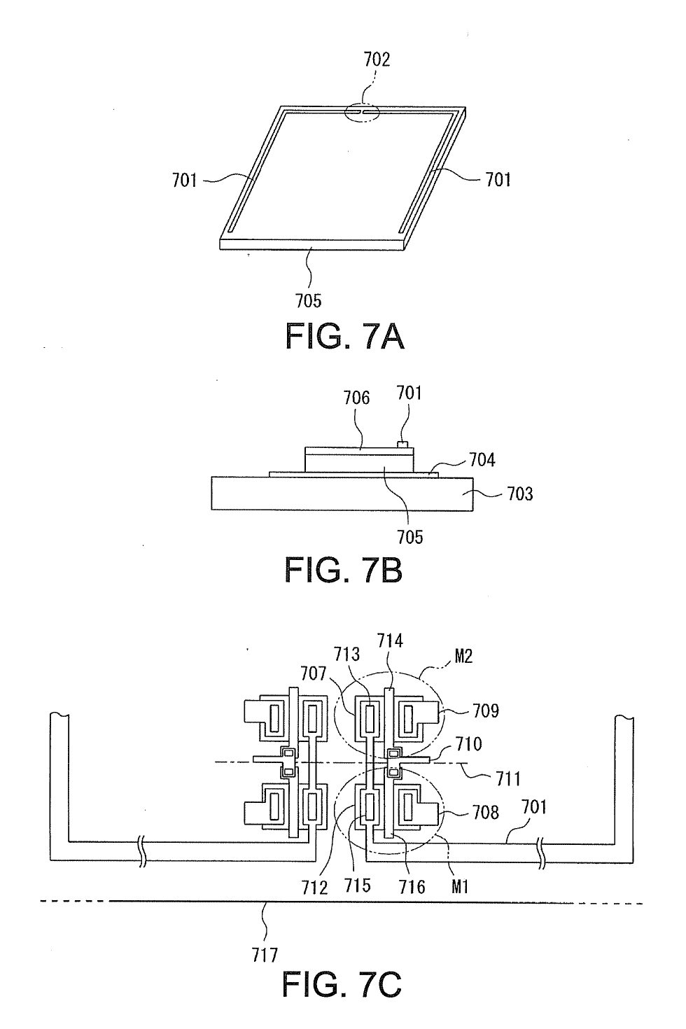

FIGS. 7A to 7C each show a case of forming an antenna conductor on a semiconductor integrated circuit. Specifically, FIG. 7A is a diagram showing the entire overview of the configuration, FIG. 7B is a cross sectional diagram thereof, and FIG. 7C is a diagram showing an enlarged portion of an electric power feeding point.

An antenna conductor 701 is formed on an integrated circuit substrate 705 using a conductive layer. With a general process for a semiconductor integrated circuit, used is a metallic layer of aluminum, copper, or others. Forming such a linear antenna element as shown in FIG. 7A is considered convenient as it does not require a large area on the integrated circuit substrate. In this embodiment, exemplified is a dipole antenna that is bent along the peripheral portion of the integrated circuit substrate 705. Reference numeral 702 denotes an electric power feeing point thereof, and FIG. 7C shows an enlarged view thereof.

FIG. 7B shows an exemplary cross sectional diagram at the time of implementation. A substrate 703 corresponds to the body-side substrate 102 in FIGS. 2A and 2B, or the display-element-side substrate 201. Reference numeral 704 is a conductive layer provided on the substrate 703. The conductive layer 704 maintains the electric potential of the integrated, circuit substrate 705, and blocks any unwanted radiation and external interference while shielding the antenna conductor 701. The antenna conductor 701 and the integrated circuit substrate 705 are insulated from each other by an insulator layer 706 made of silicon dioxide or the like.

When this insulation layer is thin, the radiation efficiency is often degraded to a considerable degree, and the frequency band is often narrowed down. In this embodiment, however, the loss caused by the integrated circuit substrate 705 is large and thus the frequency band is not narrowed down, and if anything, it is widened. Even if the loss is large, the communications distance is considerably short so that there is no problem for practical use, and if anything, the loss ensures any needed frequency band.

The integrated circuit substrate 705 is exemplified by a high-resistance substrate. Alternatively, with SOI (Silicon On Insulator) configuration or the like, an ultra-thin semiconductor layer may be formed on an insulator substrate for placement thereon of an integrated circuit, and a conductive layer may be eliminated from the portion directly below the antenna conductor 701. With this being the configuration, the radiation efficiency as an antenna is improved but the band is narrowed down. Note here that the SOI configuration does not require ensuring the electric potential of the semiconductor substrate on the underside of a chip. This accordingly allows the conductor layer 704 to be disposed opposite to the substrate 703 to be away from the integrated circuit substrate 705 so that an antenna element with a much higher efficiency can be mounted on the integrated circuit.

FIG. 7C shows an exemplary circuit driving the conductor element 701 on the integrated circuit substrate 705 described above, i.e., an exemplary case with a circuit serving as a transmission antenna.

In FIG. 7C, the integrated circuit substrate 705 is formed with complementary MOS (Metal Oxide Semiconductor) transistors M1 and M2. The MOS transistor M1 is provided with a gate 716 formed on the integrated circuit substrate 705, and the integrated circuit substrate 705 is formed with a drain 712 and a source, which are disposed so as to sandwich the gate 716 therebetween.

The MOS transistor M2 is provided with a gate 714 formed on the integrated circuit substrate 705, and the integrated circuit substrate 705 is formed with a drain 707 and a source, which are disposed so as to sandwich the gate 714 therebetween.

In FIG. 7C, an alternate long and short dashed line 711 denotes a well boundary for forming the P- or N-type MOS transistors M1 and M2. In this example, the drains 707 and 712 of the MOS transistors M1 and M2 are connected to a conductor layer via drain contacts 713 and 715, respectively. By a conductor layer which is the same as that connected to the drain 707 and 712, the antenna conductor 701 is formed, and the drains 707 and 712 of the MOS transistors M1 and M2 are connected to the conductor layer forming the antenna conductor element 701.

The gates 716 and 714 of the MOS transistors M1 and M2 are connected to a conductor layer 710 via their corresponding gate contacts. Note here that the gates 716 and 714 of the MOS transistors M1 and M2 are generally made of polysilicon, and the conductor layers 710 and 701 are made of aluminum (Al) or the like. These two gates 714 and 716 are connected together by the conductor layer 710, thereby becoming inputs of a transmission signal.

The sources of the MOS transistors M1 and M2 are connected to the conductor layers 708 and 709, respectively, via their corresponding source contacts. The sources of the MOS transistors M1 and M2 are connected to a power supply via the conductor layers 708 and 709, respectively.

This accordingly enables establishing a connection between the drains 712 and 707 of the MOS transistors M1 and M2 and the antenna conductor element 701 with no interposition of a bonding pad or a bonding wire, thereby favorably reducing any possible influence of parasitic inductance and stray capacitances.

Note here that, with a transmission antenna conductor, the conductor element 701 is connected to the drains 712 and 77, and with a reception antenna conductor, the conductor element 701 is connected to a signal reception port, i.e., the gate 710 (a case of using a source-grounded amplifier circuit), or the sources 709 and 708 (a case of using a gate-grounded amplifier circuit).

Note here that reference numeral 717 in FIG. 7C denotes a line indicating an outer edge of the integrated circuit substrate 705. The antenna conductor 701 being a linear conductor may be disposed along the periphery of the integrated circuit substrate. If this is the case, the antenna conductor 701 may not be an obstacle for other circuits in terms of packaging, for example. Between the antenna conductor 701 and the outer rim 717 of the integrated circuit substrate 705 or inside of the antenna conductor, a bonding pad or the like may be disposed for signal exchange between the integrated circuit and the outside.

As in the embodiment described above, the transmission and reception sections each including an antenna conductor are disposed on a semiconductor integrated circuit. This configuration considerably reduces the number of components and signal line connections so that there are effects of reliability improvement, increase of implementation area, size reduction, and reduction of component cost.

### Third Embodiment

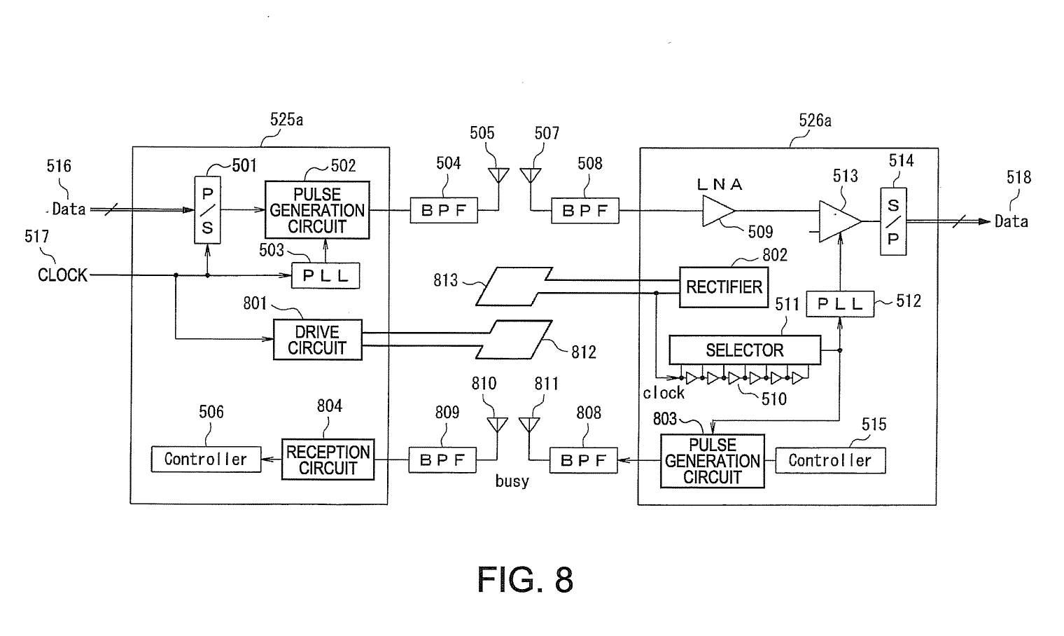

FIG. 8 shows a block diagram in a third embodiment. In this embodiment, exemplified is a case of establishing wireless connections for power supply and signals coming from the display side, i.e., perfect connector-less configuration.

In FIG. 8, any components corresponding to those of FIG. 5A described above are provided with the same reference numerals, and not described twice.

A power supply for use on the display element side is made from the body side by mutual induction via coils 812 and 813. A transmission section integrated circuit 525a on the display side subjects a clock signal provided to the terminal 517 to electrical amplification by a drive circuit 801, and drives the transmission coil 812. The coil 813 on the side of a reception section integrated circuit 526a receives energy from the coil 812 by mutual induction, and extracts the power supply energy after rectifying the energy in a rectifier circuit 802. This extracted power supply energy is supplied to the circuit and the display element. At the same time, a clock signal is extracted from the signal received by the coil 813 for use as a reference signal of the PLL 512 or a synchronizing signal of the reception section circuit.

That is, the coils 812 and 813 configure a power distribution coupling section that supplies, with no contact, an electric power by mutual conduction to the display section side where the display element is located. The power supply is made from the drive circuit 801 serving as a circuit with the power supply capability. The drive circuit 801 is disposed on the substrate side where a display signal generation section is provided in the body of an electric device for generating a display signal.

The signal to be sent out from the side of the display element (526a) to the side of the body (525a) is sent out in a manner similar to the manner of sending out the display data from the body side. That is, a signal coming from a display-element-side controller 515, e.g., busy signal, is subjected to pulse modulation by the pulse generation circuit 803, and the modulation result is sent out from the transmission antenna conductor 811 to the body side through a band-pass filter 808. On the body side, the signal is received by a reception antenna conductor 810, and then is demodulated by a reception circuit 804 through a band-pass filter 809 for output to the body-side controller 506.

The band-pass filter is not necessarily provided as long as requirements of interference resistance and interference susceptibility are satisfied. Moreover, the transmission antenna conductor 811 and the coil 813, and the reception antenna conductor 810 and the coil 812 can be shared for use through signal synthesis by any appropriate synthesis circuit. Because the conductor and the coil each have different frequency bandwidths, even if they are shared, their signals can be separated without fail with the function of the band-pass filters 808 and 809.

Such a configuration achieves no connection for signal transmission and energy transmission of power supply. There is no longer a need for a plurality of signal lines even if the transmission rate is high as a result of resolution increase of a display element, and there is no longer a need for connection by contact of a power supply. As such, there are great effects in terms of implementation and cost, i.e., the components for implementation such as connector can be omitted, and the previous various problems such as EMI can be solved all at once.

### Fourth Embodiment

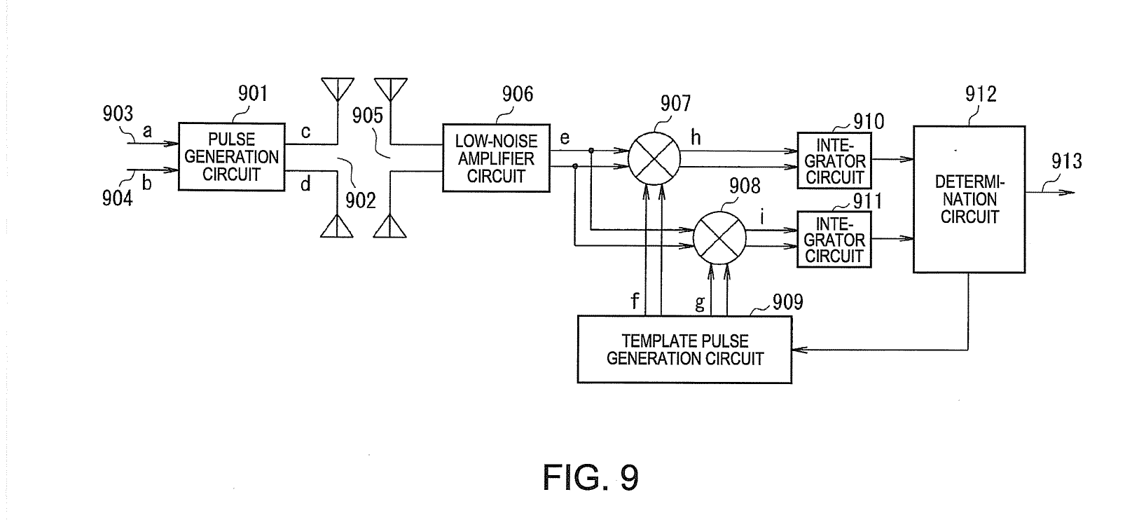

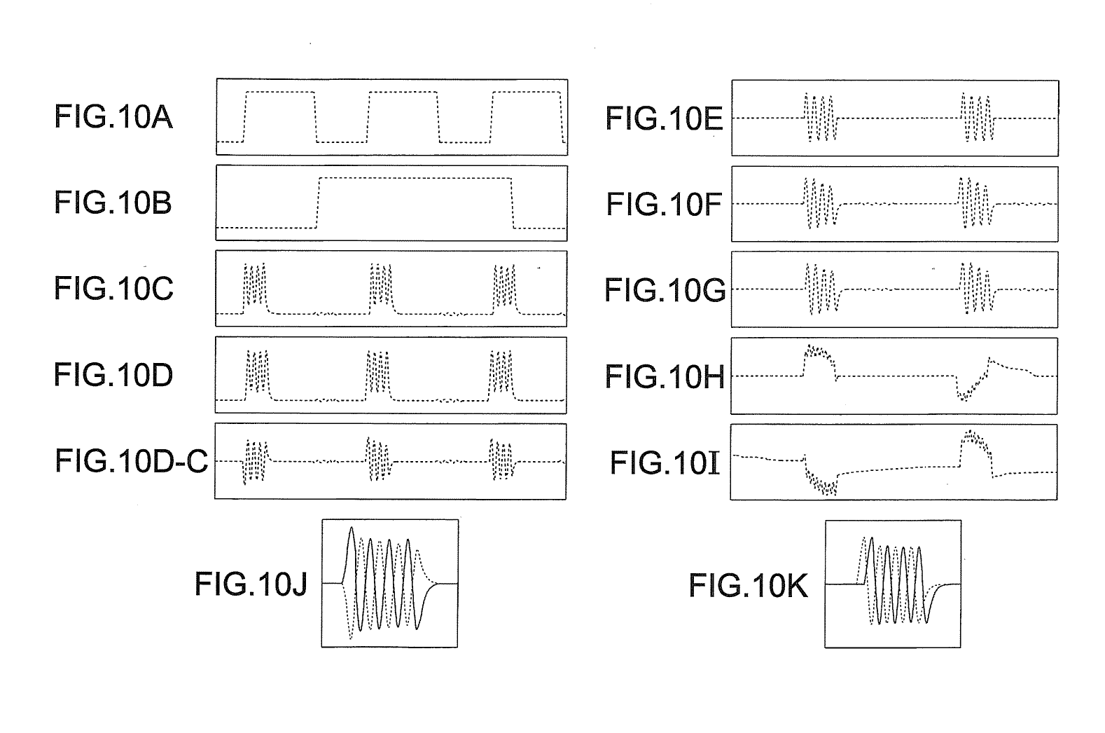

FIG. 9 shows a block diagram showing another exemplary transmission and reception for use for an electronic device or a display unit in a fourth embodiment of the invention. FIGS. 10A to 10K each show a timing diagram of the operation thereof. In this embodiment, specifically exemplified is the configuration that can fully exert the capability of interference elimination of UWB communications.

A pulse generation circuit 901 receives a seizure signal a (FIG. 10A) applied to a terminal 903, and generates a pulse. At this time, the pulse is changed and modulated in accordance with a value of transmission data b (FIG. 10B) to be input to a terminal 904. This modulation includes BPM (Bi-Phase Modulation) and PPM (Pulse Position Modulation).

If a pulse generation circuit is of a balanced type, a balanced-type antenna 902 described in the above embodiment can be driven. FIGS. 10C and 10D each show a waveform of a signal for application to a terminal of the balanced-type antenna 902, and the difference will be a signal waveform as shown in FIG. 10D-C. FIG. 10D-C shows a case with BPM. That is, when a signal b takes a value of 0, a differential signal d-c (FIG. 10D-C) generates a pulse of a polarity starting from the negative side, and when the signal takes a value of 1, generated is a pulse of a polarity starting from the positive side.

FIG. 10J shows the eye pattern of the BPM signal waveform. The value of transmission data is a factor for polarity inversion. For modulation, such a PPM as shown in FIG. 10K is also a possibility. With modulation as such, the pulse position is changed based on the value of data for sending out. The drawing shows an exemplary case with pulse shift of ½ cycle.

As an alternative configuration, two pulse generation circuits may be provided to make those operate as a pair to generate pulses orthogonal to each other. The resulting signals may be subjected to QPM (Quadrature Phase Modulation) as signals of I and Q.

An antenna 905 and the subsequent stages are of a reception circuit. That is, a UWB pulse signal received by the reception antenna 905 is amplified by a low-noise amplifier circuit 906 (FIG. 10E shows only a difference of a differential output, and this is applicable in the following), and the amplified result is input to mixer circuits 907 and 908 of the I and Q signals. The mixer circuits 907 and 908 respectively multiply template pulses f and g (FIGS. 10F and 10G) with the signals, and forward the results to integrator circuits 910 and 911. The template pulses f and g here are orthogonal to each other, being the generation results by a template pulse generation circuit 909.

FIGS. 10H and 10I show outputs of the mixer circuits 907 and 908. FIGS. 10E to 10I show an exemplary case where a template pulse and a reception signal are intentionally made out of sync to explicitly indicate the operation. During normal operation, synchronization is established in such a manner that the mixer outputs h and i takes the largest SN (Signal-to-Noise) ratio.

In the integrator circuits 910 and 911, any high-frequency component is extracted, for demodulation, from signals being the mixture (multiplication) results by the mixer circuits 907 and 908. A determination circuit 912 refers to the strength of the signals to determine the bits thereof, and puts it back to original transmission data 913.

Herein, the template pulse generation circuit 909 may be a circuit of a differential output for each of the templates I and Q, which are orthogonal to each other. The pulse generation circuit of a differential output allows the low-noise amplifier circuit 906 and the mixer circuits 907 and 908 to be of a differential type. The differential circuit is capable of cancelling out any in-phase noise, and serves well for a low-power-low-noise device mechanism because it is good for low-voltage operation. Moreover, using an IQ template enables efficient reception not only with QPM but also with BPM and PPM. That is, at the time of modulation of BPM and PPM, an I channel may be used for data demodulation, and a Q channel may be used for tracking, for example. This is because the output amplitude value is maximized with the I channel if the timing is adjusted for generation of a template, i.e., the output of the Q channel is always made 0. Such control enables tracking for synchronous detection.

With the transmitter/receiver configured as such, it is possible to suppress to a minimum any interference to any other external wireless communications systems, and any interference by very strong electromagnetic waves provided by any other wireless communications systems.

That is, on the transmission end, the pulse generation circuit 901 converts the transmission data into an electromagnetic signal of a very-wide spectrum band, and with the wide band, the energy density will be considerably low. As such, the energy in the band for wireless communications for use in any other external communications systems will be low, and the correlation is low with signals for use in the systems so that the interference waves will be minimized. Moreover, a signal of any external communications systems to be received from the outside as an interference wave will be dispersed by the mixer circuits 907 and 908. The signal dispersion is about a band of a template pulse to be generated by the template pulse generation circuit 909. On the other hand, a signal transmitted by the antenna 902 is dispersed inversely because the correlation with the template is high, and the result of a large signal is output from the mixer circuits 907 and 908. In this manner, any external strong signal can be suppressed to a minimum in terms of interference wave.

As described in the embodiments above, any possible leakage of the electromagnetic energy to the outside is small because the distance between the antenna conductors is short, the electromagnetic energy coming from a transmitter is small from the beginning, and not only a radiation field that attenuates with an inverse proportion to the distance but also an induction field and an electrostatic field that attenuate with an inverse proportion to the square and third power of the distance can be used. What is more, the transmission and reception antenna conductors can be shielded with ease so that any possible leakage to the outside and any mixture therefrom can be suppressed. Still more, utilizing the capability of interference elimination of UWB communications leads to considerable robustness with respect to any disturbance.

With such a configuration, even with a system in which a transmitter emitting strong waves is housed in a small cabinet, e.g., mobile phone, there is no possibility of interference against transmitter signals of the phone function. Moreover, as compared with a case of using connectors of physical connection, the interference against a receiver that receives weak waves coming from a distance and any possible unwanted radiation that will interfere with external devices can be reduced.

With a CMOS integrated circuit, the power is consumed only during a transition time of pulse generation, i.e., no idling current. When such a circuit is used in a communication device, the power consumption can be always minimized depending on the amount of information (bit rate) for transmission.

### Fifth Embodiment

In the first embodiment, an antenna conductor is formed by a conductive pattern, and in the second embodiment, at least one of transmission and reception antenna conductors are formed on their corresponding semiconductor integrated substrates. Described in a fifth embodiment is an exemplary case of forming an antenna conductor on a glass substrate configuring a liquid crystal display element.

In an active matrix liquid crystal display element, an active element such as switching element is formed on a substrate made of glass or the like for forming a display element panel. The active element is often configured by a thin-film transistor formed on a crystalline silicon film or an amorphous silicon film formed on a glass substrate.

The substrate is not restrictive to a glass substrate, and possible options include a quartz substrate or plastic substrate, for example. The display element may be an EL (organic electroluminescent), SED, and others.

Compared with an element such as transistor formed on a general single-crystal semiconductor substrate, these elements show poor capabilities such as switching speed but can be formed with the liquid crystal panel, thereby being popular not only for pixel switching but also for a matrix driver.

Using such an element, a circuit or an element including the components of this aspect of the invention, i.e., wireless reception section, wireless transmission section, and antenna conductor, can be partially or entirely formed.

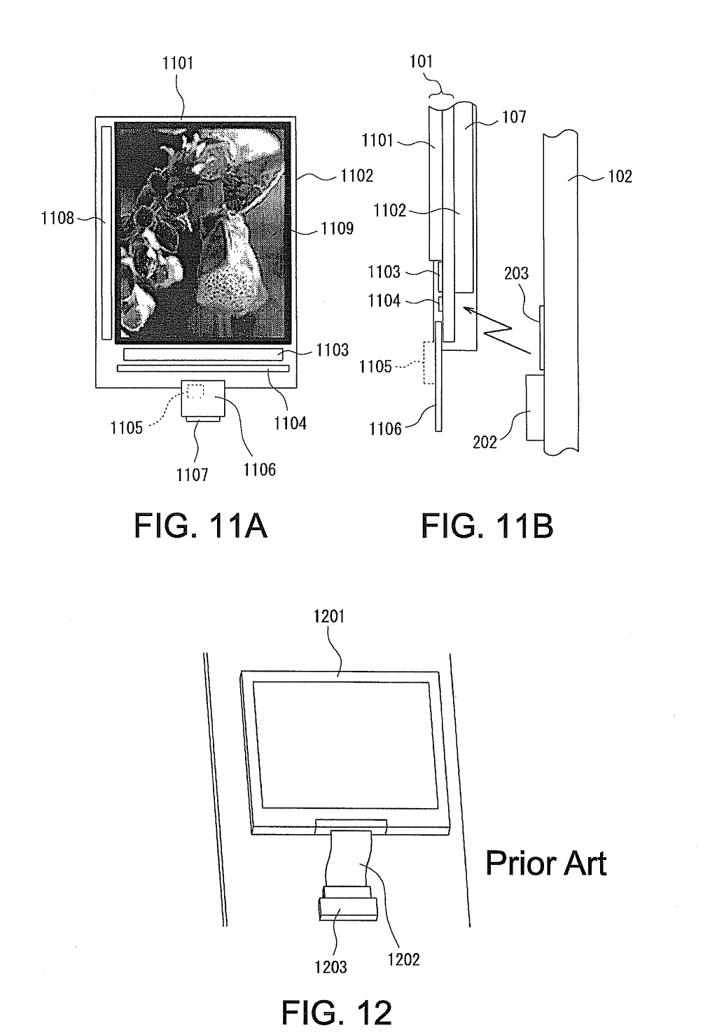

By referring to FIGS. 11A and 11B, a description is made more in detail. FIG. 11A is a front view of the display element in its entirety, and FIG. 11B is a detailed side view of a wireless coupling section. In FIGS. 11A and 11B, components corresponding to those of FIGS. 1A to 2B are provided with the same reference numerals, and not described twice.

A liquid crystal display element is configured by including two glass substrates 1101 and 1102 or the like with a liquid crystal layer sandwiched therebetween. These substrates 1101 and 1102 are each formed with a wiring pattern of liquid crystal pixels thereon and a switching element. FIG. 11A and 11B each show a case where a liquid crystal X driver 1103 and a liquid crystal Y driver 1108 are formed on the lower substrate 1102.

A display area 1109 is formed with a switching element being a thin-film transistor for every pixel, and driver for driving such switching elements is formed on the substrate in the same process.

In this embodiment, exemplarily, the lower substrate 1102 is formed with the X driver 1103 and the Y driver 1108. Signals of display data emitted from the transmission antenna conductor 203 are received by a reception antenna conductor 1104 formed on the substrate 1102 of the display element.

In this embodiment, the reception antenna conductor 1104 is made of a conductive layer, which forms a wiring pattern on the liquid crystal display element. With a liquid crystal display element, a transparent conductive film such as ITO (Indium Tin Oxide) is popular. Because this film is high in resistance, a metallic layer or the like may be additionally provided by evaporation, for example, and the conductivity may be increased.

A conductive layer formed on the display element substrate is generally high in resistance, and is low in efficiency for use as an antenna. However, with the high resistance, the band can be wide. The low efficiency can be compensated by increasing the power on the transmission end.

Increasing the power on the transmission end means increasing the influence over the outside. With the case in the embodiment, the distance between the transmission and reception ends is considerably short, thereby not requiring such an increase of power as much as affecting the outside. As in the second embodiment, compared with a case of forming an antenna conductor on a semiconductor integrated circuit substrate, the size thereof can be increased. As such, the selection options of the frequency band for use can be increased, and any frequency band with less influence over the outside can be selected. Moreover, the measures of shielding or the like can be taken as described above.

A substrate 1106 is disposed on the substrate 1102 of the display element for supply of power to the display element, or for connection of low-speed signals (410 and 407 in FIG. 4) described by referring to FIGS. 4 or FIGS. 5A to 5E. The substrate is generally a tape substrate or a film substrate, for example, and the material thereof is often a polyimide resin, or the like.

The substrate 1106 is mounted thereon with a connector 1107 for connection of a power supply and signals, and establishes a connection with the outside. When the active element formed on the substrate 1102 of the display element is not enough in terms of characteristics, and when no circuit can be formed for a demodulation section that demodulates display data from any received signal, the circuit of the demodulation section may be partially or entirely formed by an integrated circuit by any other semiconductor processes for mounting use.

In such a case, an integrated circuit 1105 supporting a part or the entire circuit of the demodulation section is disposed on the substrate 1106 or on the substrate 1102 of the display element.

With such a configuration, the number of components to be disposed on the display element can be reduced, thereby achieving high reliability, low cost, and small size. Especially the drivers 1103 and 1108 can be reduced in size for placement in the vicinity of a display area 1109 so that the display area 1109 can be increased in size, i.e., up to the outer shape of the display element. This serves well for size reduction of the display element.

The invention is not restricted only to signal connection in a mobile phone in a liquid crystal display element, i.e., between a body portion and a display section. The invention is applicable to display connection in various types of electronic devices using a display element, e.g., a notebook computer.

What is claimed is:

1. A display unit that receives a signal from a display control section and makes a display corresponding to display data represented by the signal, the unit comprising:
a display element;
a drive unit that drives the display element;
a wireless reception section that wirelessly receives the signal from the display control section as an electromagnetic signal; and
a demodulation unit that reproduces the display data from the electromagnetic signal received by the wireless reception section and supplies the reproduced display data to the drive unit.

2. The display unit according to claim 1, further comprising:
a power reception section that wirelessly receives electric energy for the display element, the drive unit, and the demodulation unit.

3. The display unit according to claim 1, wherein the wireless reception section receives a modulating signal from transmission elements which are paired and opposed to a section including a conductor of the wireless reception section, the modulating signal being related to the display data to be supplied to the transmission elements.

4. The display unit according to claim 3, wherein the wireless reception section and the transmission elements are enclosed by the conductor in the pair.

5. The display unit according to claim 2, further comprising:
a substrate supporting a conductor of the wireless reception section, and at least one of the display element, the drive unit, and the power reception section.

6. The display unit according to claim 2, wherein
the wireless reception section includes a conductor that is integrated onto an integrated circuit substrate that supports a circuit configuring the power reception section.

7. The display unit according to claim 1, wherein:
the wireless reception section and transmission elements which are paired and opposed to a section including a conductor of the wireless reception section form a coupling section for wirelessly transmitting the electromagnetic signal, and
the coupling section includes an inductance element that transfers electric energy by electromagnetic induction.

8. The display unit according to claim 1, wherein the demodulation unit includes a UWB demodulation section that receives a UWB-modulated UWB signal representing the display data provided by the display control section, and extracts a signal representing the display data from the received UWB signal.

9. An electronic device, comprising:
a display signal generation section that generates a display signal representing display object data;
a display section that makes a display on a display element based on the display signal generated by the display signal generation section; and
a coupling section that is interposed on a transmission path on which the display signal is transmitted to the display section, wherein the coupling section includes:
a wireless transmission section that wirelessly sends out the display signal and is configured as part of a circuit of the display signal generation section or on a substrate supporting the circuit; and
a wireless reception section that wirelessly receives the display signal and is configured as part of the display element of the display section or on a substrate supporting a drive circuit that drives the display element.

10. The electronic device according to claim 9, wherein:
the wireless transmission section of the coupling section includes at least one of:
a transmission element that emits an electromagnetic wave in response to an output of a transmission modulation circuit section generating a carrier signal resulting from modulation performed in accordance with the display signal,
an inductance element of inductive coupling, and
a capacitive element of electrostatic coupling, and
the wireless reception section of the coupling section includes a reception element that receives the electromagnetic wave emitted by the transmission element for supply to a demodulation circuit for demodulating the display signal based on the electromagnetic wave.

11. The electronic device according to claim 9, wherein:
a transmission element of the coupling section includes a conductor having a predetermined shape, the transmission element being disposed on the substrate supporting the circuit of the display signal generation section, and
a reception element of the coupling section includes a conductor having a predetermined shape, is the reception element being disposed on the substrate supporting the drive circuit for driving the display element of the display section.

12. The electronic device according to claim 10, wherein:
the transmission element of the coupling section includes a conductor having a predetermined shape, the transmission element being disposed on the substrate supporting the circuit of the display signal generation section, and
the reception element of the coupling section is formed in a semiconductor integrated circuit on the substrate supporting the display element of the display section.

13. The electronic device according to claim 10, wherein:
the transmission element and the reception element of the coupling section are disposed to both be at least partially within a sphere having a radius of one-half of π (π is a circular constant) of a wavelength of the electromagnetic wave to be transmitted and received between the transmission element and the reception element.

14. The electronic device according to claim 10, further comprising:
a distribution coupling section that wirelessly supplies electric power by mutual induction to a side of the display section from a power supply circuit disposed on a side of the substrate supporting the circuit of the display signal generation section.

15. An electronic device, comprising:
a UWB modulation section that subjects transmission data to UWB modulation to convert the data into an electromagnetic signal for output;
an emission section that emits, as an electromagnetic wave, the electromagnetic signal provided by the UWB modulation section;
a reception section that receives energy of the electromagnetic wave emitted by the emission section; and
a UWB demodulation section that subjects, the electromagnetic signal received by the reception section to UWB demodulation;
wherein the emission section and the reception section are disposed with a minimum distance therebetween equal to one-half of n or smaller of a maximum wavelength of the electromagnetic signal to be emitted by the emission section.

16. An electronic device, comprising:
a display signal generation section that generates a display signal representing display object data;
a display section that makes a display on a display element based on the display signal generated by the display signal generation section; and
a coupling section that is interposed on a transmission path on which the display signal to be generated by the display signal generation section is transmitted to the display section;
wherein the coupling section includes:
a wireless transmission section including a semiconductor integrated substrate and a transmission element for wirelessly sending out the display signal provided by the display signal generation section; and
a wireless reception section including a semiconductor integrated circuit and a reception element for receiving the display signal wirelessly provided by the wireless transmission section, and
at least one of the transmission element and the reception element are formed on the semiconductor integrated circuits.

17. An electronic device, comprising:
a display signal generation section that generates a display signal representing display object data;
a display section that makes a display on a display element formed on a substrate based on the display signal generated by the display signal generation section; and
a coupling section that is interposed on a transmission path on which the display signal generated by the display signal generation section is transmitted to the display section;
wherein the coupling section includes:
a wireless transmission section including a transmission element for wirelessly sending out the display signal provided by the display signal generation section; and
a wireless reception section including a reception element for receiving the display signal wirelessly provided by the wireless transmission section, and
the reception element is formed on the substrate.
